(19) United States
(12) Patent Application Publication
(10) Pub. No.: US 2012/0028585 A1
(43) Pub. Date: Feb. 2, 2012

(54) COMMUNICATION SYSTEM AND COMMUNICATION PROGRAM

(76) Inventor: Mayumi Takada, Kyoto (JP)

(21) Appl. No.: 12/672,782

(22) PCT Filed: Jul. 17, 2008
(86) PCT No.: PCT/JP08/62919

§ 371 Date: Feb. 9, 2010

(30) Foreign Application Priority Data
Aug. 17, 2007 (JP) 2007-212805

(51) Int. Cl. H04B 17/00

(52) U.S. Cl. 455/67.11

(57) ABSTRACT

A communication system to enable a communication between different places including: a transmitting section which transmits information from a first place in order to detect whether a communication partner is present at a second place; a detection section which receives the information and detects whether the communication partner is present; and a judgment section which, in cases where the communication partner is detected to be present, determines whether the communication partner is possible of communication.

### TECHNICAL FIELD

The present invention relates to a communication system and a communication program for enabling a communication between different places.

### BACKGROUND TECHNOLOGY

Communication systems enabling the communication between different places via networks are developing day by day with increasing capacity of communication circuits represented by a broad band and enhanced performance of computers in the systems. As a communication system, there is a system which bi-directionally transmits high quality color images with voices in real time. For example a teleconference system in business fields is available, with which talking with a plurality of persons displayed in life size is possible in realistic sensation.

Meanwhile, in cases where a person at a certain place wants to communicate with an intended person at the other place, it is required to confirm whether the intended person is available at the other place. Unexamined Japanese Patent Application Publication No. 2003-283666 (Patent Document 1) discloses the technology which enables a high accuracy presence management by making cooperation of Near Field Communication such as Bluetooth, and a scheduler. According to the technology described in the Patent document 1, it is easily confirmed whether the communication partner is present at the other place or not.

### DISCLOSURE OF THE INVENTION

### Problems to be Solved by the Invention

Even in cases where the communication partner is confirmed to be present at the other place, the case may be possible that the intended person cannot communicate such that the partner is being engaged in a work, or talking with other person. In these cases, trying to communicate from the other place may be annoying to the communication partner.

An object of the present invention is to provide a communication system and a communication program for realizing favorable communication with an communication partner.

### Means for Solving the Problems

In order to achieve the above-described object, a communication system relating the present invention is the system to enable a communication between different paces characterized in having: a transmitting section which transmits information from a first place in order to detect whether a communication partner is present at a second place; a detection section which receives the information and detects whether the communication partner is present; and a judgment section which, in cases where the communication partner is detected to be present, determines whether the communication partner is possible of communication.

A communication program relating to the present invention is the communication program to enable a communication between different paces, characterized in allowing a computer to execute the steps of: a transmitting step to transmit information from a first place in order to detect whether a communication partner is present at a second place; a detecting step to receive the information and detect whether the communication partner is present; and a judging step, in cases where the communication partner is detected to be present, to determine whether the communication partner is possible to communicate.

### EFFECT OF THE INVENTION

According to the communication system and the communication program relating to the present invention, a favorable communication with a communication partner can be realized.

### BRIEF DESCRIPTION OF THE DRAWINGS

FIG. 1 is a schematic diagram of a communication system.

FIG. 2 is a block diagram of a communication system.

FIG. 3 is a flow diagram relating to a communication operation.

FIG. 4 is a diagram showing a relationship between amount of signals and time.

FIG. 5 is an example of displaying a result of determination.

FIG. 6 is an example of displaying a result of determination.

FIG. 7 is an example of displaying a result of determination.

FIG. 8 is a block diagram of a communication system.

### EXPLANATION OF CODE

1: Communication system
10, 30 Network server
20A, 20B, 20C, 20D: Terminal
40A, 40B, 40C, 40D: Terminal
201, 401: Display
202, 402: Keyboard
203, 403: Mouse
204, 404: Pen
205, 405: Camera
206, 406: Microphone
207, 407: Speaker
301: Detection section
302: Judgment section
501: Pressure sensor

### DETAILED DESCRIPTION OF THE PREFERRED EMBODIMENT

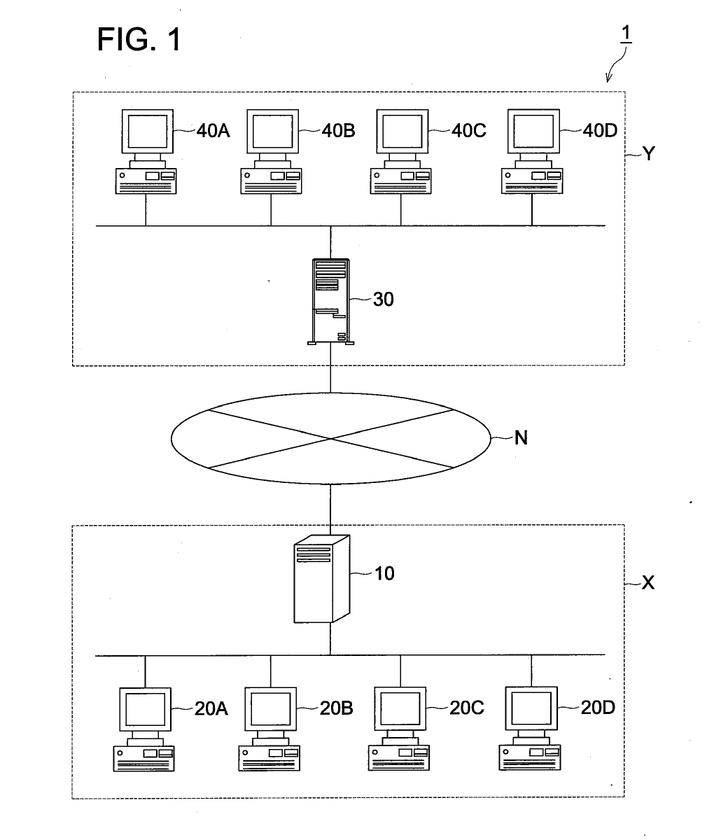

FIG. 1 is a schematic diagram of the communication system 1 relating to the present invention.

Office room X and office room Y located at different places are connected via network N, and a bi-directional communication is capable between the offices.

In office room X, network server 10 is installed, and to this network server (computer) 10, a plurality of terminals (computers) 20A-20D are connected via a LAN (Local Area Network). Similarly, in office room Y, network server (computer) 30 is installed, and to this network server 30, a plurality of terminals (computers) 40A-40D are connected via a LAN. In FIG. 1, 4 terminals are installed in each office rooms, however the number of the terminals may be another number.

A communication program is installed in terminals 20A-20D in office room X, terminals 40A-40D in office room Y, and to network servers 10 and 30, and the communication between users in different office rooms are made possible. For example a user of terminal 20A in office room X is possible to communicate with a user of terminal 40A in office room Y. By the use of communication system 1 shown in FIG. 1, persons at remote places are possible to communicate with each other.

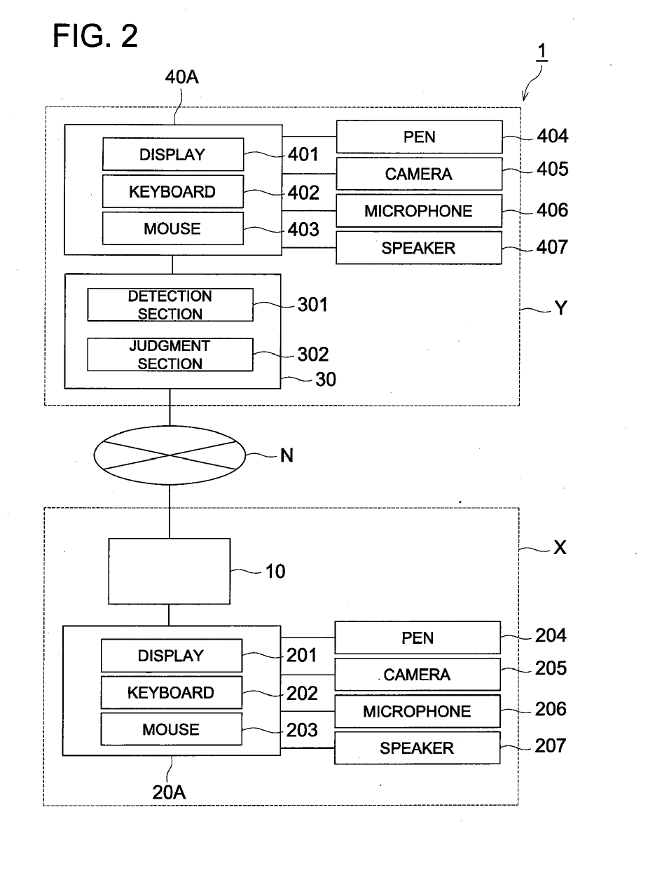

FIG. 2 is a block diagram of the communication system representing a typical configuration. In FIG. 2, only terminal 20A among the terminals in office room X is illustrated, and only terminal 40A in office room Y is illustrated.

Terminals 20A and 40A have same structures. In each terminal, a display, a keyboard, and a mouse is installed, and a pen, a camera, a microphone and a speaker are externally connected to each of the terminals.

Each display of 201 and 401 displays an application screen activated in each terminal, and an image of the communication partner. Displays 201 and 401 preferably have high resolution and large screens in order to display the image of the communication partner.

Keyboards 202 and 402, and mousse 203 and 403 are used to employ the application activated in each of the terminals.

Each pen of 204 and 404 is used in cases of inputting character information to each terminal.

Each camera of 205 and 405 is used to take pictures of a person using the each terminal. For example in cases where a user of terminal A and a user of terminal B are going to communicate with each other, the image taken with camera 205 is displayed on display 401 of terminal 40A, and the image taken with camera 405 is displayed on display 201 of terminal 20A.

Each of microphones 206 and 406 functioning as a voice detector collects the voice of the user at each terminal. For example, the voice collected by microphone 406 is transmitted to speaker 207 via network N. Microphones 206 and 406 are preferably stereo microphones in order to enhance the realistic sensation.

In network server 30 of office room Y, detection section 301 and judgment section 302 are installed.

Detection section 301 is for detecting whether a prescribed user is present in office room Y. There are various types of method for detecting whether the prescribed user is present in office room Y. For example, when coming-in or going-out an office room, a person who enters the office room allows his or her IC card to be read by a reading sensor installed at the doorway of the room to read the IC card, and the presence of the person is detected based on the information having been read. Further, by the use of a Near Field Communication such as Bluetooth it may be possible to detect which person is present.

Judgment section 302 judges whether or not the communication partner is possible of communication. By obtaining the status of the communication partner, judgment section 302 judges whether the communication is possible or not. The method of judgment will be described later.

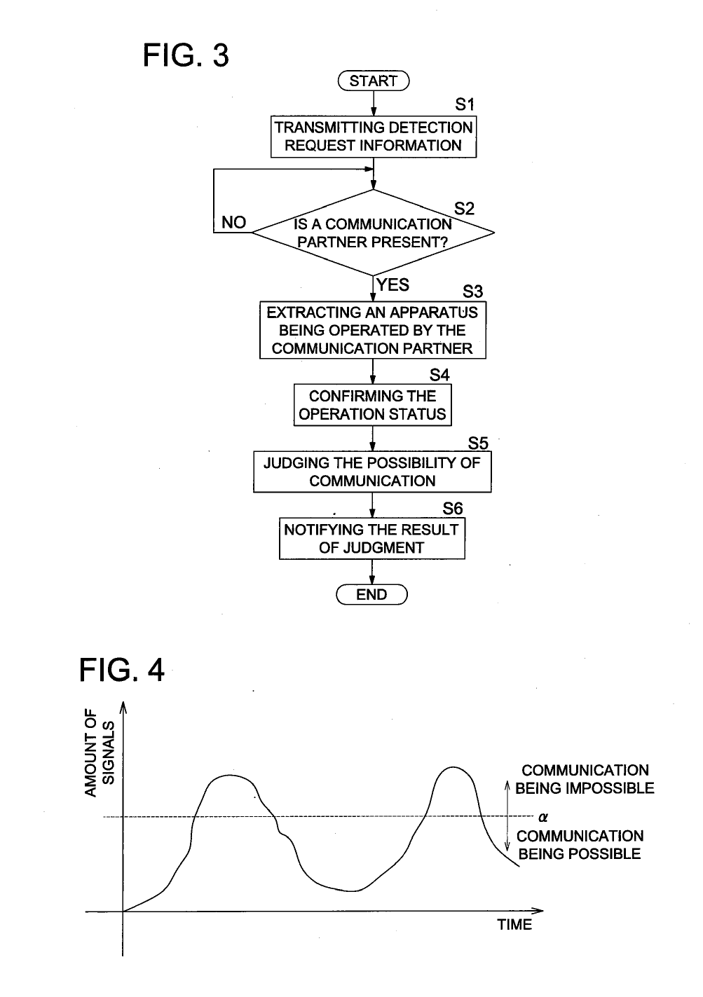

In cases where a user of terminal 20A in the office room X requires to make communication with a user of terminal 40A in the office room Y, it may be possible that the user of terminal 40A is in a condition of not being able to communicate because of engaging in a work, or talking with other person and the like. In these cases, trying to communicate from the user of terminal 20A will be annoying to the user of terminal 40A. Therefore, in addition to detecting whether the communication partner is present at the place of communication, the communication system judges whether the intended person is possible to communicate. This is described by referring to FIG. 3.

FIG. 3 is a flow diagram relating to the communication operation. By referring to FIG. 3, the communication operation is explained in cases where the user of terminal 20A in the office room X makes communication with the user of terminal 40A in the office room Y.

Firstly, terminal 20A (transmitting section in this case) transmits, to network server 30, detection request information for detecting whether the communication partner (the user of terminal 40A, in this case) is present in the office room Y (step S1).

When receiving the detection request information, network server 30 detects whether the communication partner is present in the office room Y (step S2). The detection is executed by detection section 301 in network server 30.

When the communication partner is detected to be present in the office room Y, in the next place extracted is an apparatus which being operated by the communication partner (step S3). In the network server 30, a data table correlating users and the apparatuses is preliminarily stored. By referring to the data table, the concerned apparatus is extracted. The data table to be referred may be the one correlating the user and the apparatus by utilizing login information of the terminal. Judgment section 302 in network server 30 executes the extraction and extracts terminal 40A in this case.

When the apparatus of the communication partner is extracted, an operation status of the communication partner regarding the apparatus is confirmed (step S4), and based on the operation status it is judged whether the communication partner is possible to communicate or not (step S5). This judgment is executed by judgment section 302 in the network server 30.

The judgment in step S5 is executed by confirming the operation status of keyboard 402 in terminal 40A. FIG. 4 illustrates the relationship between amount of signals and time. In FIG. 4, the horizontal axis shows the elapsed time and the vertical axis shows the amount of signals of keyboard in terminal 40A.

When the user is concentrating to works on terminal 40A, the input operation at key board 402 is assumed to be increased, thus in such status making communication becomes difficult. Since in cases where the input operation increases the amount of signals from the key board increases, judgment section 302 judges such that “communication is impossible” when the amount of signals exceeds the reference value α as shown in FIG. 4, and “communication is possible” when the amount of signals is less than the reference value α. Further, it may be possible to take the total amount of signals from mouse 403 and pen 404 in addition to that from key board 402 into consideration for judging the possibility of communication.

In step S5 of FIG. 3, when whether the communication is possible or not is judged, the judgment result is notified to terminal 20A which has transmitted the detection request information (step S6).

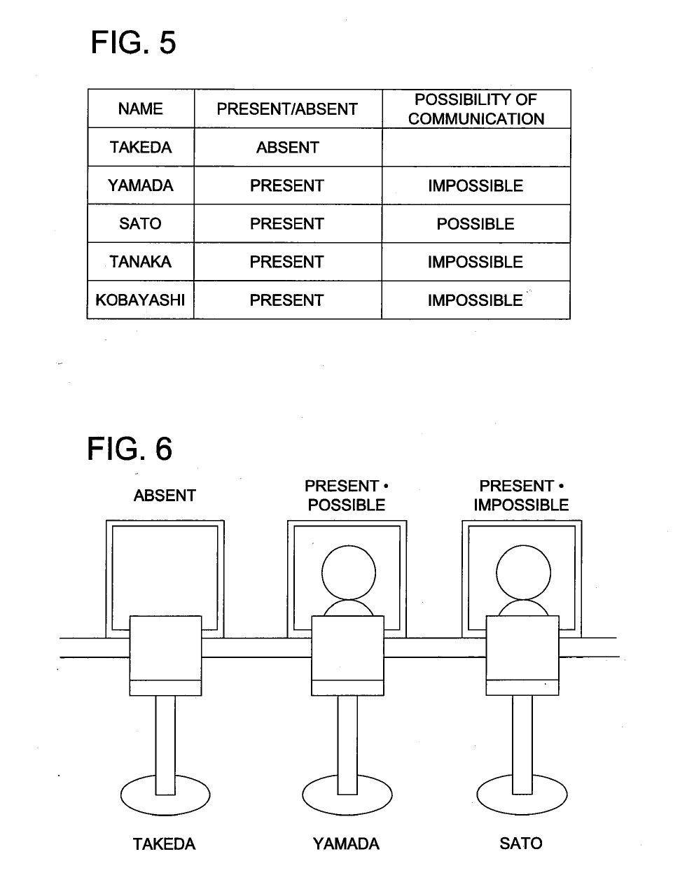

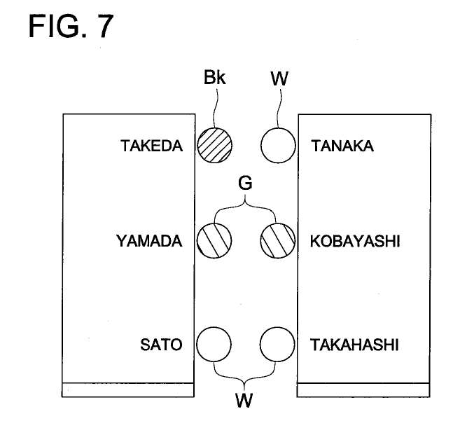

FIGS. 5 through 7 illustrate examples of showing the judgment result.

The result judged by judgment section 302 in the network server 30 is displayed on display 201 of terminal 20A which transmitted the detection request information.

For example, items of “name”, “present/absent” and “possibility of communication” are displayed in table as shown in FIG. 5. In this way by seeing the result of judgment displayed on display 201, the user of terminal 20A can determine whether the communication is possible, and make communication at appropriate time.

The result of judgment may also be displayed as shown in FIG. 6. With the visual display as that in FIG. 6, it is easily recognized who is present in the office room X and the like.

Further the result of judgment may be distinctly displayed with colors. In case where the communication partner is absent, the result may be displayed with solid black circle, in case where the partner is present in the room but impossible of communication, displayed with gray circle, and in case where the partner is present in the room and possible of communication, displayed with white circle.

By seeing the result of judgment on display 201 as shown in FIGS. 5-7, the user of terminal 20A may make a communication via the network or call the communication partner by a telephone if the communication partner is possible of communication. In cases of placing a telephone call, when the communication is possible the user may calls up the partner, and when the communication is impossible, the user may only leave a call resister without a sound of beep.

Further, the result of judgment may be distinctly notified to the user of terminal 20A by music, light, wind, or a flavor, without using display 201.

As explained above by using FIGS. 3-7, by detecting whether the communication partner is present, and by judging whether the communication partner is possible to communicate, it is enabled to make appropriate communication without psychological burden or without annoying the communication partner.

In the explanation of FIG. 4, although the judgment whether the communication is possible is executed by confirming the operation status of the keyboard in terminal 40A, the other methods are also applicable.

Firstly, there is a method of judgment whether the communication is possible based on the type of application being activated in the apparatus operated by the communication partner.

For example, in cases where an IP phone or an application relating to communication is being activating, it is judged that the communication is impossible. Further, by classifying the applications installed in the terminal into business use and breath-fresher (such as a game), if the application for business use is activated judged is that the communication is impossible, and if the application of breath-fresher is activated, judged may be that the communication is possible. Further, the judgment may be executed by the combination of the operation status and the type of the application.

As another judgment method, there is a method of judging by a voice. By microphone 406 connected to terminal 40A, the voice of the user of terminal 40A is detected, and if the amount of the voice signals is greater than a reference value, since the communication partner is highly possible of talking with the other person, the judgment results in impossible of communication, and if the amount of the voice signals is less than the reference value, the judgment results in possible of communication.

Further, by recognizing whom the communication partner talking with, if the partner is talking with the superior, the judgment results in impossible of communication, and if the partner is talking with a colleague, the judgment may result in possible of communication.

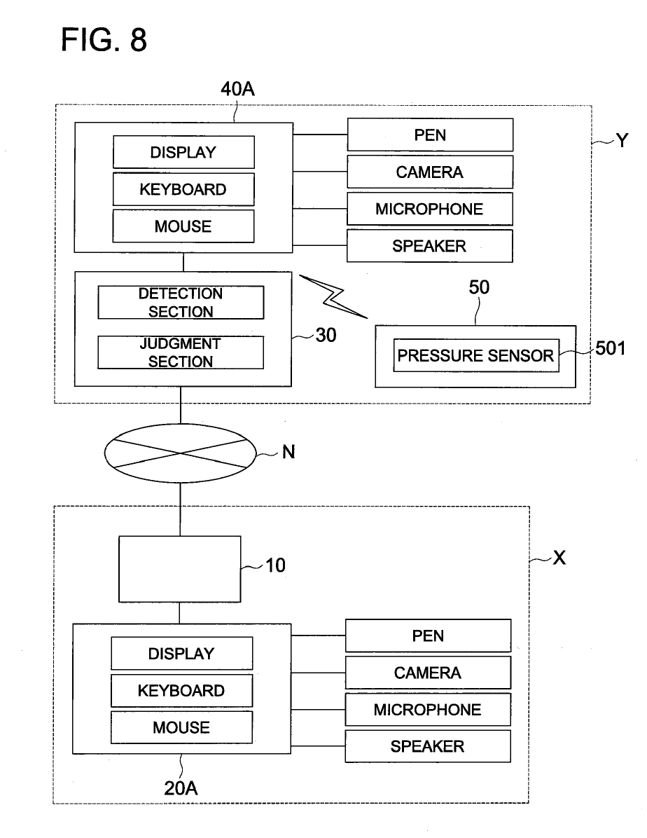

Further, there is a method of judgment based on a posture of the communication partner. As shown in FIG. 8, pressure sensor (posture detection section) 501 is installed on chair 50 taken by the user of terminal 40A, and signals detected by the pressure sensor 501 are wirelessly transmitted to terminal 40A. If the signals detected by pressure sensor 501 is stable, by recognizing that the user is concentrated to terminal 40A, the judgment results in impossible of communication, and if the signals detected by pressure sensor 501 is not stable, by recognizing that the user is not so much concentrated to terminal 40A, the judgment results in possible of communication.

Further, there is also a method where recognizing the posture of the communication partner using a camera, and judging whether the communication is possible based on detection of the posture variation of the communication partner. For example, if the posture variation of the communication partner recognized by the camera is large, the partner is judged as not being concentrated to the terminal, and the judgment result in possible of communication.

Further, postures for possible communication and postures for impossible communication are classified into patterns and preliminarily stored in a data base, the posture recognized by the camera is judged to which pattern it matches, and the judgment of possible communication is executed. For example, the posture for possible communication is that the communication partner stays remotely off the terminal, or bends backward with clasping the hands behind the head, and the posture for impossible communication is that the partner stares the screen carefully with a hand on the mouth, or looks the display carefully with crossing the arms on the chest.

Further, there may also be a method of judging whether the communication is possible, based on the line of sight, degree of open/close of eyes, number of times of blinking, and the facial expression of the communication partner.

In the case of judging based on the line of sight of the communication partner, if the range of line of sight movement is fixed in the display during a certain time period, the judgment results in impossible communication. For example, if the range of line of sight movement is fixed for approximately five minutes, it is judged to be impossible of communication.

In the case of judging based on the degree of open/close of eyes of the communication partner, if the state of closing eyes continues more than 0.5 sec, the partner is highly possible to be sleeping or be going to sleep, then it is judged to be possible of communication.

In the case of judging based on the number of times of blinking of the communication partner, for example, if the interval of blinking is 5 sec or more or the low-pass filtered number of blinking times in a certain period is more than twofold, it is judged to be impossible of communication.

In the case of judging based on the facial expression of the communication partner, facial expressions for possible communication and facial expressions for impossible communication are classified into patterns and preliminarily stored in a data base, the facial expression recognized by the camera is judged to which pattern it matches. For example, the facial expression for possible communication is that of smiling, and the facial expression for impossible communication is that of knitted brows or being angry.

Although embodiments of the present invention have been described referring to the drawings, the present invention is not restricted to the described embodiments, but modifications or additions are included the present invention within the range of not deviating from the gist of the present invention.

In the present embodiment, although detection section 301 and judgment section 302 are provided in network server 30 of office room Y, these sections may be provided in the other apparatus (for example, network server 10 in office room X) if the similar functions are exerted.

1. A communication system to enable a communication between different places, comprising:
a transmitting section which transmits information a first place in order to detect whether a communication partner is present at a second place;
a detection section which receives the information and detects whether the communication partner is present; and
a judgment section which, in cases where the communication partner is detected to be present, determines whether or not the communication partner is possible of communication.

2. The communication system of claim 1, wherein the judgment section extracts an apparatus which is operated by the communication partner, and judges whether or not the communication partner is possible of communication based on an operation status of the communication partner with respect to the extracted apparatus.

3. The communication system of claim 1, wherein the judgment section extracts an apparatus which is operated by
the communication partner, and judges whether or not the communication partner is possible of communication based on a type of application being activated on the extracted apparatus.

4. The communication system of claim 1, further comprising a voice detection section, wherein the judgment section judges whether or not the communication partner is possible of communication based on a result of voice detection by the voice detection section.

5. The communication system of claim 1, further comprising a posture detection section, wherein the judgment section judges whether or not the communication partner is possible of communication based on a result of posture detection by the posture detection section.

6. The communication system of claim 1, further comprising a notifying section, wherein the notifying section notifies a result of judgment by the judgment section to the first place.

7. A computer-readable storage medium having stored therein a communication program for enabling a communication between different places, the program allowing a computer to execute the steps of:
transmitting step to transmit information from a first place in order to detect whether a communication partner is present at a second place;
a detecting step to receive the information and detect whether the communication partner is present; and
a judging step to judge whether or not the communication partner is possible of communication, in cases where the communication partner is detected to be present.

8. The computer-readabale storage medium of claim 7, wherein the judging step extracts an apparatus which is operated by the communication partner, and judges whether or not the communication partner is possible of communication based on an operation status of the communication partner with respect to the extracted apparatus.

9. The computer-readable storage medium of claim 7, wherein the judging step extracts an apparatus which is operated by the communication partner, and judges whether or not the communication partner is possible of a communication based on a type of application being activated on the extracted apparatus.

10. The computer-readable storage medium of claim 7, wherein the judging step judges whether or not the communication partner is possible of communication based on a voice emitted by the communication partner.

11. The computer-readable storage medium of claim 7, wherein the judging step judges whether or not the communication partner is possible of communication based on a posture of the communication partner.

12. The computer-readable storage medium of claim 7, wherein the program further allows a computer to execute a notifying step to notify a result of judgment by the judging step to the first place.
